(19) United States
(12) Patent Application Publication
(10) Pub. No.: US 2024/0106944 A1
(43) Pub. Date: Mar. 28, 2024

(54) READING DEVICE AND IMAGE FORMING APPARATUS

(71) Applicant: FUJIFILM Business Innovation Corp., Tokyo (JP)

(72) Inventor: Yosuke TAKAHASHI, Kanagawa (JP)

(73) Assignee: FUJIFILM Business Innovation Corp., Tokyo (JP)

(21) Appl. No.: 18/151,528

(22) Filed: Jan. 9, 2023

(30) Foreign Application Priority Data
Sep. 28, 2022 (JP) 2022-155018

(51) Int. Cl. H04N 1/00; H04N 1/10

(52) U.S. Cl. CPC H04N 1/00549; H04N 1/00559; H04N 1/1061; H04N 1/23; H04N 2201/0428

(57) ABSTRACT

A reading device includes: a transparent flat plate with an upper surface on which an object to be read is placed; a reading unit reading information on the object while moving in contact with a transparent flat plate lower surface; a retainer retaining the reading unit by urging the reading unit to be pressed against the lower surface; a guide member supporting and guiding the retainer along a movement direction at a time of reading by the reading unit; and a positioning structural member in at least one end of the reading unit and the retainer in a direction crossing the movement direction to position the reading unit to be maintained being displaceable relative to the retainer in a direction to be closer to and in a direction to be away from the transparent flat plate and being non-displaceable upstream and downstream in the movement direction.

### CROSS-REFERENCE TO RELATED APPLICATIONS

This application is based on and claims priority under 35 USC 119 from Japanese Patent Application No. 2022-155018 filed Sep. 28, 2022.

### BACKGROUND

### (i) Technical Field

The present disclosure relates to a reading device and an image forming apparatus.

### (ii) Related Art

Japanese Unexamined Patent Application Publication No. 2021-145262 (claim 1, paragraph [0035], FIG. 2, FIG. 4) describes a reading device including: a housing in which an opening is formed; a substrate on which a light shielding member, an optical member, and a light receiving device to be housed and mounted in the housing are disposed; and a shaft that supports and guides the housing in a direction of movement at the time of reading. The housing is slidably supported by the shaft and moved with a sliding member provided in the lower surface of the housing.

Japanese Unexamined Patent Application Publication No. 2020-155845 (claim 1, FIG. 2, FIG. 4, FIG. 5) describes an image reading device including: an image reading unit that moves in a sub-scanning direction to read an image; a storage that stores the image reading unit; a support provided in the lower surface of the storage unit, the support having inclined surfaces formed in a symmetrical Japanese katakana character “HA” shape spreading laterally in both right and left in a direction crossing the sub-scanning direction; and a guide unit provided to come into contact with the support and extend in the sub-scanning direction, the guide unit being configured to movably guide the support relatively to the guide unit.

### SUMMARY

Aspects of non-limiting embodiments of the present disclosure relate to a reading device in which vibration of a reading unit relative to a retainer for the reading unit upstream and downstream in the movement direction at the time of reading by the reading unit is prevented, as compared to when a positioning structural member is not provided which positions the reading unit so that the reading unit is maintained in a state of being displaceable relative to the retainer in a direction to be closer to and in a direction to be away from a transparent flat plate on which an object to be read is placed and in a state of being non-displaceable upstream and downstream in the movement direction at the time of reading, the reading unit being configured to move and read information on the object to be read while being in contact with the lower surface of the transparent flat plate.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a reading device including: a transparent flat plate, on an upper surface of which an object to be read is placed; a reading unit that reads information on the object to be read while moving in contact with a lower surface of the transparent flat plate; a retainer that retains the reading unit by urging the reading unit to be pressed against the lower surface of the transparent flat plate; a guide member that supports and guides the retainer along a movement direction at a time of reading by the reading unit; and a positioning structural member provided in at least one end of the reading unit and the retainer in a direction crossing the movement direction to position the reading unit so that the reading unit is maintained in a state of being displaceable relative to the retainer in a direction to be closer to and in a direction to be away from the transparent flat plate and in a state of being non-displaceable upstream and downstream in the movement direction.

### BRIEF DESCRIPTION OF THE DRAWINGS

Exemplary embodiments of the present disclosure will be described in detail based on the following figures, wherein:

FIG. 1 is a schematic view of a reading device according to Exemplary Embodiment 1;

FIG. 2 is a schematic top view of the reading device of FIG. 1 with an opening and closing cover removed;

FIG. 3A is an enlarged schematic view of part of the reading device of FIG. 1, and FIG. 3B is a schematic cross-sectional view taken along line IIIB-IIIB of FIG. 3A;

FIG. 4A is a schematic top view of a reading unit and a retainer in the reading device, and FIG. 4B is a schematic top view with the reading unit of FIG. 4A retained by the retainer;

FIG. 5A is a schematic side view of the reading unit and the retainer in the reading device, and FIG. 5B is a schematic side view with the reading unit of FIG. 5A retained by the retainer;

FIG. 6A is another schematic side view of the reading unit and the retainer in the reading device, and FIG. 6B is another schematic side view with the reading unit of FIG. 6A retained by the retainer;

FIGS. 7A and 7B are views related to a reading device according to Exemplary Embodiment 2, FIG. 7A is a schematic top view of a reading unit and a retainer in the reading device, and FIG. 7B is a schematic top view with the reading unit of FIG. 7A retained by the retainer;

FIG. 8A is a schematic side view of the reading unit and the retainer in the reading device of FIGS. 6A and 6B, and FIG. 8B is a schematic side view with the reading unit of FIG. 8A retained by the retainer;

FIG. 9 is a schematic view of an image forming apparatus including a reading device according to Exemplary Embodiment 3;

FIG. 10 is an enlarged schematic view of an imaging unit in the image forming apparatus of FIG. 9;

FIGS. 11A and 11B are views related to Modification 1 of a positioning structural member in a reading device, FIG. 11A is a schematic side view of a reading unit and a retainer provided with the positioning structural member in Modification 1, and FIG. 11B is a schematic side view with the reading unit of FIG. 11A retained by the retainer;

FIGS. 12A and 12B are views related to Modification 2 of a positioning structural member in a reading device, FIG. 12A is a schematic top view of a reading unit and a retainer provided with the positioning structural member in Modification 2, and FIG. 12B is a schematic top view with the reading unit of FIG. 12A retained by the retainer; and

FIG. 13A is a schematic side view of the reading unit and the retainer in the reading device of FIGS. 12A and 12B, and FIG. 13B is a schematic top view with the reading unit of FIG. 13A retained by the retainer.

### DETAILED DESCRIPTION

Hereinafter, an exemplary embodiment for implementing the present disclosure will be described.

### Exemplary Embodiment 1

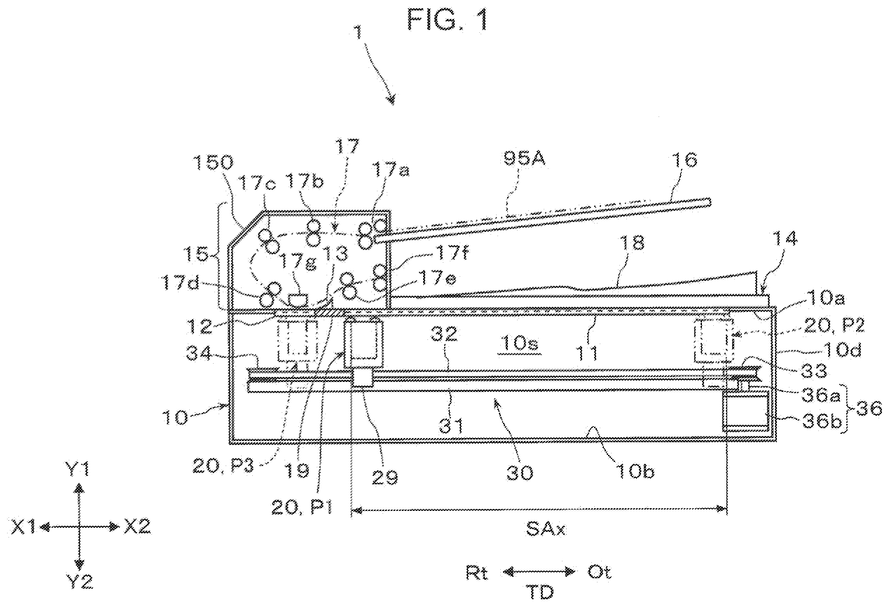

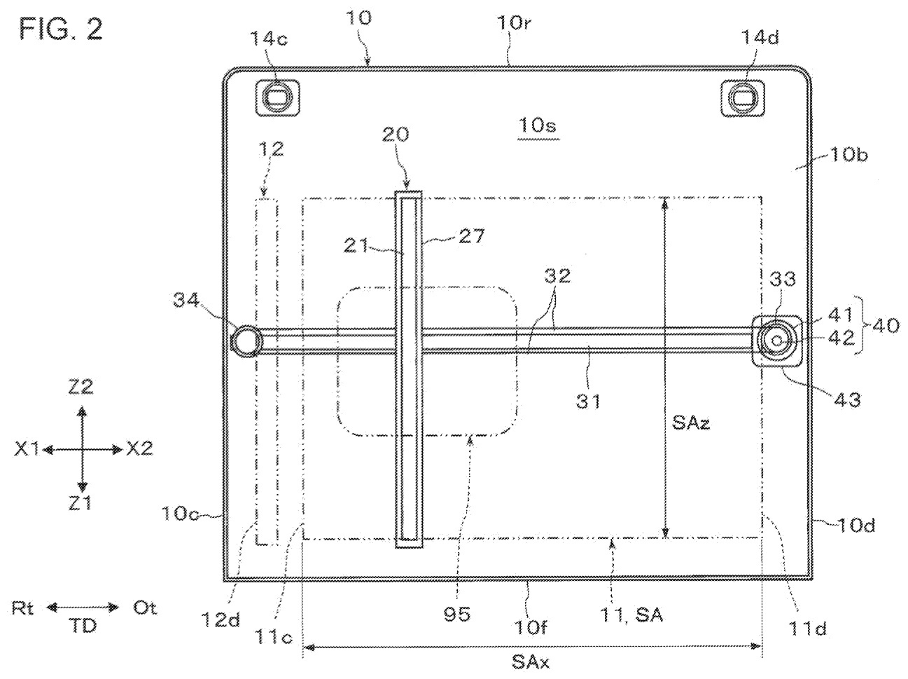

FIG. 1 is a schematic cross-sectional view of a reading device 1 according to Exemplary Embodiment 1 of the present disclosure. FIG. 2 is a schematic top view of the reading device 1 of FIG. 1 with an opening and closing cover removed.

Essentially the same components in the present specification and the drawings are labeled with the same symbol, and a redundant description of those components is omitted in the present specification.

As illustrated in FIG. 1 and FIG. 2, the reading device 1 includes: a housing 10 provided with a first transparent flat plate 11 at an upper portion, the first transparent flat plate 11 being an example of a transparent flat plate on which an object to be read 95 is placed; a reading unit 20 that comes into contact with a lower surface 11b of the first transparent flat plate 11 to read information on the object to be read 95; and a movement unit 30 that moves the reading unit 20 back and forth within a scan area SA.

It is sufficient that the object to be read 95 be an object which can be placed on an upper surface 11a of the first transparent flat plate 11, and can be read by the reading unit 20. As the object to be read 95, for example, a sheet-like document 95A (see FIG. 1), and a book may be mentioned.

The housing 10 is a structural body having a substantially box shape, and internally has a storage space 10s. As illustrated in FIG. 1, FIG. 2 in a distributed manner, the storage space 10s is the space surrounded by an upper surface portion 10a, a bottom surface portion 10b, a left-side surface portion 10c, a right-side surface portion 10d, a front wall surface portion 10f and a rear wall surface portion 10r.

In the housing 10, the first transparent flat plate 11 comprised of a clear glass for placing the object to be read 95 is installed in an opening provided in part of the upper surface portion 10a.

The first transparent flat plate 11 is used in a fixed document reading mode in which the object to be read 95 as a document is read in a fixed state. Such first transparent flat plate 11 may be referred to as a platen glass.

In the first transparent flat plate 11, its planar part has a rectangular shape consisting of horizontal dimension SAx along the left and right directions X1, X2 (also corresponding to the width direction) of the reading device 1, and depth dimension SAz (see FIG. 2.) along front and rear directions Z1, Z2 (also corresponding to the depth direction) of the reading device 1.

Furthermore, the first transparent flat plate 11 is configured so that its planar area substantially corresponds to the scan area SA in a fixed document reading mode.

Additionally, in the housing 10, a second transparent flat plate 12 comprised of a clear glass is installed in an opening provided in another part of the upper surface portion 10a.

The second transparent flat plate 12 is used in a moving document reading mode in which a sheet-like document 95A is read in a moving state, the document 95A being an example of the object to be read 95.

In the second transparent flat plate 12, its planar part has an elongated rectangular shape consisting of a horizontal short dimension along the left and right directions X1, X2 of the reading device 1, and a depth dimension along the front and rear directions Z1, Z2 of the reading device 1.

Furthermore, in the housing 10, the upper surface portion 10a is provided with an opening and closing cover 14 that covers the first transparent flat plate 11 and the second transparent flat plate 12.

As illustrated in FIG. 1, the opening and closing cover 14 in Exemplary Embodiment 1 is formed as an openable and closable cover provided with an automatic document transport device 15 that automatically transports and passes the sheet-like document 95A, which is an example of the object to be read 95, through the second transparent flat plate 12.

Symbols 14c, 14d in FIG. 2 indicate hinge mounting sections for mounting hinges (not illustrated) disposed rearward of the opening and closing cover 14.

As illustrated in FIG. 1, the automatic document transport device 15 includes: a device body 150 having a document transport path 17 for transporting the sheet-like document 95A along a needed path; a document placing tray 16 on which sheet-like documents 95A are placed in a stacking manner; and a document storage section 18 into which the document 95A after being read is discharged and stored.

The device body 150 is a structural body having an exterior member provided with a document inlet port and a document discharge port (not illustrated), and a storage space inside the exterior member. The device body 150 is disposed near at one (the left-side end in this example) of the ends of the reading device 1 in the left and right directions X1, X2 when viewed from the front side of the reading device 1.

The document transport path 17 transports the sheet-like document 95A placed on the document placing tray 16 so that the document 95A comes into contact with and passes through at least the upper surface of the second transparent flat plate 12, and is finally discharged to the document storage section 18.

The document transport path 17 is formed by disposing, at needed positions, multiple transport roller pairs 17a, 17b, 17c, 17d, 17e, 17f, a transport guide member (not illustrated), and a drive device (not illustrated) that provides power to rotate the transport roller pairs 17a, 17b, 17c, 17d, 17e, 17f in and at needed direction and speed.

A symbol 17g in FIG. 1 indicates a proximity guidance member that guides the sheet-like document 95A so that the document 95A approaches and passes through the upper surface of the second transparent flat plate 12.

A symbol 13 in FIG. 1 indicates a separation guidance member that guides the document 95A after passing the second transparent flat plate 12 so that the document 95A is separated from the second transparent flat plate 12. The separation guidance member 13 is disposed at the boundary between the first transparent flat plate 11 and the second transparent flat plate 12 of the upper surface portion 10a of the housing 10.

Furthermore, a symbol 19 in FIG. 1 indicates a flat plate-like plate member disposed between the first transparent flat plate 11 and the second transparent flat plate 12. The lower surface of the plate member 19, facing the storage space 10s of the housing 10 is colored white.

The document placing tray 16 is provided as a plate-shaped tray which is present above the opening and closing cover 14, over the space where the device body 150 is not present so as to project from one side of the device body 150 in a slightly inclined manner.

The document storage section 18 is provided as a base section composed of, for example, a wave-like storage curved surface on the upper surface portion of the opening and closing cover 14, where the device body 150 is not present.

The reading unit 20 is a unit that is disposed inside the housing 10, and receives reflected light obtained when the object to be read 95 is illuminated, then converts the reflected light to an electrical signal. The reading unit 20 in Exemplary Embodiment 1 is comprised of an instrument using the contact image sensor (CIS) method.

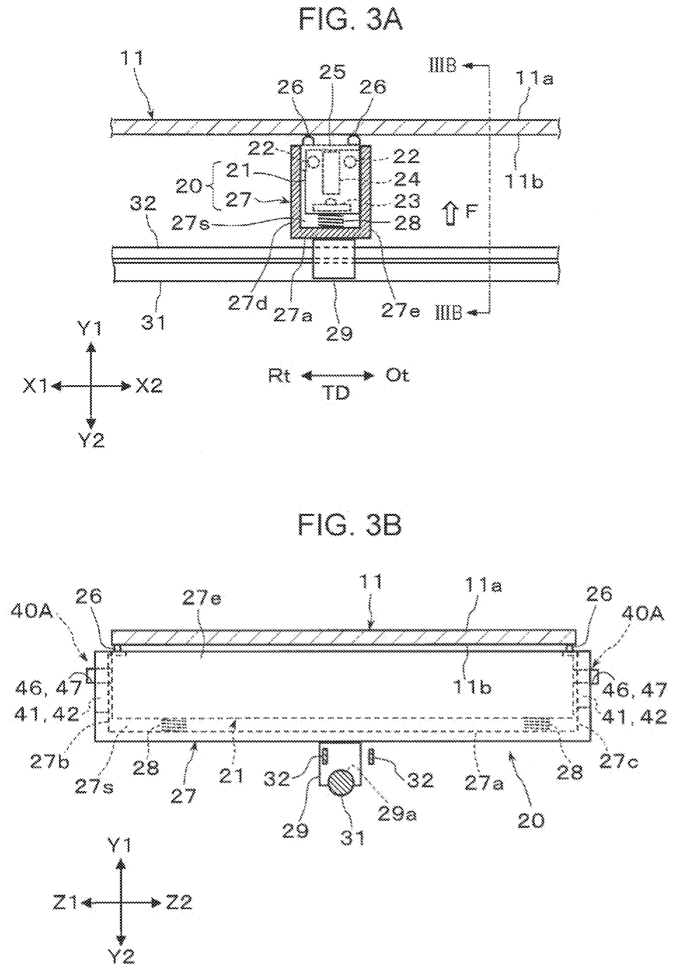

As illustrated in FIGS. 3A and 3B, the reading unit 20 using CIS is comprised of a cuboid-shaped reading body 21 which is elongated in the front and rear directions Z1, Z2 (also corresponds to the depth direction) of the reading device 1, and a retainer 27 that stores and retains the reading body 21.

In the reading body 21, as illustrated by a dashed line in FIG. 3A, a light emitting array 22, a light receiving substrate 23, and a condenser lens array 24 are disposed in a cuboid-shaped case (not illustrated) which is elongated in the front and rear directions Z1, Z2 of the reading device 1 and has an open upper surface.

The light emitting array 22 is an instrument that emits light to illuminate the object to be read 95 (with the first transparent flat plate 11 interposed therebetween). The light receiving substrate 23 is a substrate on which a light receiving device, and components of an electronic instrument or the like are disposed, the light receiving device being configured to receive reflected light obtained when the object to be read 95 is illuminated by the light emitting array 22 and convert the reflected light to an electrical signal. The condenser lens array 24 is an optical component that condenses and guides reflected light obtained when the object to be read 95 is illuminated by the light emitting array 22 to the light receiving substrate 23.

The light emitting array 22 and the light receiving substrate 23 in the reading body 21 are coupled to a controller which is not illustrated.

As illustrated in FIG. 3A, the upper surface at both ends of a case (not illustrated) for the reading body 21 is provided with contact sections 26 that come into contact with and slide along the lower surface 11b of the first transparent flat plate 11.

The contact sections 26 are provided on the upper surface of a support plate 25 (see FIG. 3A), for example, at positions opposed to the lower surface 11b of the first transparent flat plate 11 and on the upper surface at both ends of the reading body 21 in the longitudinal direction (corresponds to the front and rear directions Z1, Z2 of the reading device 1) of a case (not illustrated), the support plate 25 being in contact with the upper surface of the case and the wall surface on one side of the later-described storage space (27s) of the retainer 27. The contact sections 26 project from the upper surface of the support plate 25 by a needed dimension, and their upper ends are formed in a shape composed of a curved surface.

The retainer 27 is a structural body having a storage space 27s into which the reading body 21 is fitted from above and stored.

As illustrated in FIGS. 3A and 3B, the retainer 27 in Exemplary Embodiment 1 has: a rectangular base plate 27a which is elongated along the front and rear directions Z1, Z2; short side sidewalls 27b, 27c that stand perpendicularly from the short sides at both ends of the base plate 27a in the longitudinal direction; and long side sidewalls 27d, 27e that stand perpendicularly from the long sides on both sides of the base plate 27a along the longitudinal direction. The storage space 27s is the space surrounded by the base plate 27a, the short side sidewalls 27b, 27c, and the long side sidewalls 27d, 27e. Note that the retainer 27 may be a structural body having no long side sidewalls 27d, 27e.

In the bottom surface of the storage space 27s of the retainer 27, an urging member 28 is disposed which urges the reading body 21 stored and retained in the storage space 27s toward the lower surface 11b of the first transparent flat plate 11 with an elastic urging force F (in the upward direction Y1) so that the reading body 21 is pressed against the lower surface 11b. A member such as a spring is used as the urging member 28, for example.

The lower surface of the retainer 27 is provided with a coupling mounting member 29 which is mounted so as to be coupled to part of the movement unit 30.

As illustrated in FIG. 3B, the coupling mounting member 29 is provided in a state of being projected downward from the lower surface of the retainer 27. A lower portion of the coupling mounting member 29 is provided with a semicircular cross-sectional sliding groove 29a to be mounted and slidably coupled to the later-described guide member 31 of the movement unit 30 while receiving and supporting the guide member 31. The coupling mounting member 29 is mounted so that part of the later-described movement member 32 of the movement unit 30 is fixed and connected to one side (for example, the front side) of an upper portion of the coupling mounting member 29.

Note that the coupling mounting member 29 may be divided into a first coupling mounting member for mounting the guide member 31 and a second coupling mounting member for mounting part of the movement member 32.

The movement unit 30 is a unit disposed inside the housing 10 to move the reading unit 20 in the direction (back-and-forth movement direction) TD in which back-and-forth movement of the reading unit 20 is made.

The actual movement unit 30 in Exemplary Embodiment 1 includes the guide member 31, the movement member 32, rotary supports 33, 34, and a motor 36. The movement unit 30 is disposed to be positioned below the reading unit 20 inside the housing 10.

The guide member 31 is a member that supports and guides the reading unit 20 along the back-and-forth movement direction TD at the time of reading.

The guide member 31 is comprised of, for example, a substantially circular rod-shaped guide bar, and is disposed along the back-and-forth movement direction TD inside the storage space 10s of the housing 10.

As illustrated in FIG. 3B, the guide member 31 is mounted to be coupled to the coupling mounting member 29 of the retainer 27 of the reading unit 20 in a state of slidably penetrating the coupling mounting member 29.

The movement member 32 is a member that is fixed to part of the retainer 27, and arranged and moved along the guide member 31. The movement member 32 is comprised of an endless belt or a wire, for example. As illustrated in FIG. 3B, part of the movement member 32 is mounted to be coupled to the coupling mounting member 29 of the retainer 27 in a fixed state.

The rotary supports 33, 34 rotate while movably supporting the movement member 32. The rotary supports 33, 34 are comprised of two pulleys that rotatably support, for example, an endless belt which is an example of the movement member 32 by winding the endless belt on the pulleys.

The pulleys (hereinafter may be referred to as a first pulley 33, a second pulley 34) as an example of the rotary supports 33, 34 are rotatably disposed at positions in the vicinities substantially corresponding to both ends of the guide member 31 in the longitudinal direction.

More specifically, the first pulley 33 is disposed at a position outward (further rightward) of a right-side end 11d of the first transparent flat plate 11 in the left and right directions X1, X2 in a state of overlapping with the right-side end 11d when viewed from above. In addition, the second pulley 34 is disposed at a position outward (further leftward) of a left-side end 12c of the second transparent flat plate 12 in the left and right directions X1, X2 in a state of overlapping with the left-side end 12c when viewed from above.

When the fixed document reading mode is selected, as illustrated in FIG. 1, the movement unit 30 causes the reading unit 20 to make a back-and-forth movement between a home position (P1) substantially corresponding to a left-side end 11c of the first transparent flat plate 11 in the left and right directions X1, X2 and a turn back stop position (P2) substantially corresponding to the right-side end 11d of the first transparent flat plate 11.

When the moving document reading mode is selected, as illustrated in FIG. 1, the movement unit 30 causes the reading unit 20 to move to a reading stop position (P3) almost immediately below the second transparent flat plate 12 and maintains the reading unit 20 at a stopped state.

The motor 36 is an electric motor that provides power to the movement unit 30.

As illustrated in FIG. 1, the motor 36 includes a motor body 36a, and a drive shaft 36b. The motor body 36a is a body in which components to cause the drive shaft 36b to rotate are internally stored. The drive shaft 36b is a shaft that outputs rotational power in a state of projecting from one end of the motor body 36a.

The motor 36 is directly connected to, for example, the shaft of one rotary support 33 (for example, the first pulley 33) between the rotary supports 33, 34. In addition, the motor 36 is designed to transmit rotational power to the rotary support 33 while switching between normal and reverse directions, and finally to rotate and move the movement member 32 in a needed direction between the rotary supports 33, 34. In other words, the motor 36 provides the power for moving the movement member 32 so that the reading unit 20 is moved in the back-and-forth movement direction TD by a predetermined distance between the rotary supports 33, 34.

Also, when the reading device 1 is used as an independent reading device by being connected to an information terminal, necessary component devices such as a power supply device, an operation section, and a controller which are not illustrated are disposed inside or outside the housing 10.

The operation section is a section in which operation components, such as a power switch, operation selection buttons, a start button, and a stop button are disposed. The operation section may include a display, such as a liquid crystal panel, on which information such as operation contents is displayed. The controller controls the reading unit 20, a drive device such as the motor 36, and the operation of a power supply device or the like.

### Operation of Reading Device

The reading device 1 is capable of reading in the fixed document reading mode and reading in the moving document reading mode.

When the fixed document reading mode is selected, the reading device 1 operates in the following manner.

In this case, the reading device 1 is first set in a state where the opening and closing cover 14 is opened, and a needed object to be read 95 is placed on the upper surface 11a of the first transparent flat plate 11, and finally, the reading device 1 is set in a state where the opening and closing cover 14 is closed.

Subsequently, in the reading device 1, upon receiving a start command for a read operation from an operation section which is not illustrated, the motor 36 is started to operate the movement unit 30.

Thus, after receiving detected information indicating that the object to be read 95 is placed on the upper surface 11a of the first transparent flat plate 11, the reading unit 20 moves from the home position almost immediately below the plate member 19 to the read start position P1 almost immediately below the left-side end 12c of the first transparent flat plate 11. The reading unit 20 is moved by the retainer 27 receiving a movement action of the movement unit 30.

Thereafter, the reading unit 20 is moved immediately below the first transparent flat plate 11 from the read start position P1 in the outward direction Ot in the back-and-forth movement direction TD at a needed speed. At this point, the reading unit 20 is moved to the turn back stop position P2 almost immediately below a right-side end 12d of the first transparent flat plate 11, and stopped.

In the reading device 1, when the reading unit 20 is moved in the outward direction Ot, information on the object to be read 95 is read by the reading unit 20. Thus, the outward direction Ot may be called the movement direction (hereinafter may be referred to as the movement direction Ot) at the time of reading by the reading unit 20. The information on the object to be read 95 can be read by the reading unit 20, and is used as a piece of information on image, for example.

Finally, in the reading device 1, the retainer 27 receives a movement action of the movement unit 30, generated by reverse drive of the motor 36.

Thus, the reading unit 20 is moved from the turn back stop position P2 in the return direction Rt in the back-and-forth movement direction TD at a needed speed, and is returned to the read start position P1, then is moved to the home position and stopped.

In the reading device 1, reading is performed in the above manner with the object to be read 95 as a document fixed.

Next, when the moving document reading mode is selected, the reading device 1 operates in the following manner.

In this case, the reading device 1 is first set in a state where the opening and closing cover 14 is closed, and the sheet-like document 95A is placed on the document placing tray 16 of the automatic document transport device 15.

Subsequently, in the reading device 1, upon receiving a start command for a read operation from an operation section which is not illustrated, the motor 36 is started to operate the movement unit 30.

Thus, after receiving detected information indicating that the sheet-like object to be read 95A is placed on the document placing tray 16, the reading unit 20 is moved from the home position to the reading stop position P3 almost immediately below the second transparent flat plate 12, and is stopped.

Subsequently, in the reading device 1, the automatic document transport device 15 starts, and thus the sheet-like document 95A on the document placing tray 16 is transported through the document transport path 17 and passed through the second transparent flat plate 12.

In the reading device 1, information on the sheet-like document 95A, which is moved to pass through the second transparent flat plate 12, is read by the reading unit 20 stopped at the reading stop position P3. The read sheet-like document 95A is discharged to and stored in the document storage section 18 of the automatic document transport device 15.

Finally, in the reading device 1, the retainer 27 receives a movement action of the movement unit 30, generated by re-driving of the motor 36. Consequently, the reading unit 20 is returned from the reading stop position P3 to the home position, and is stopped at the home position. In the reading device 1, reading is performed in the above manner with the sheet-like document 95A moved.

### Positioning Structural Member in Reading Unit

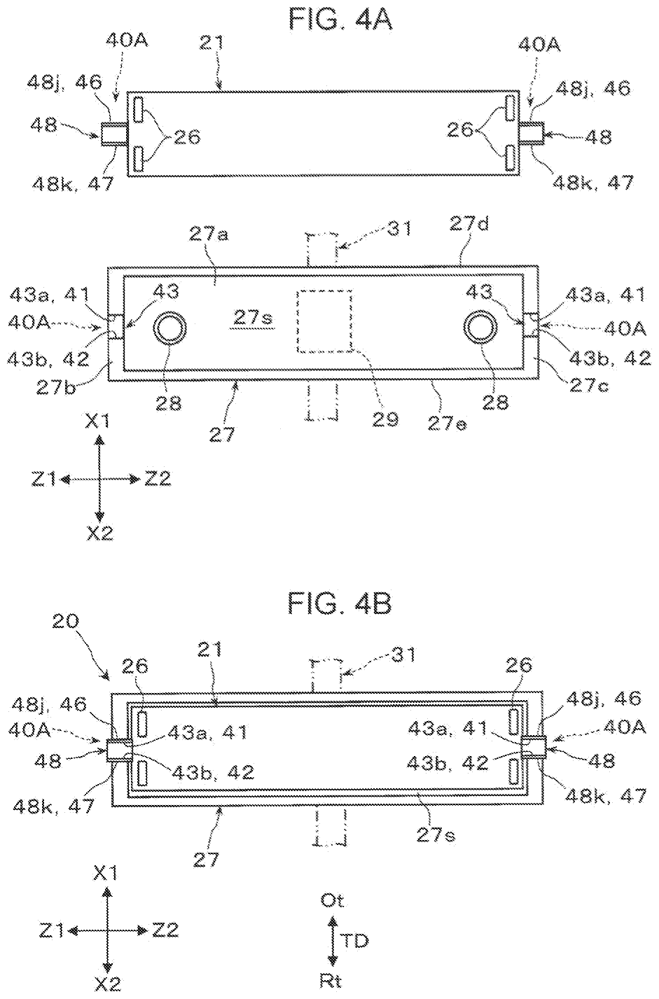

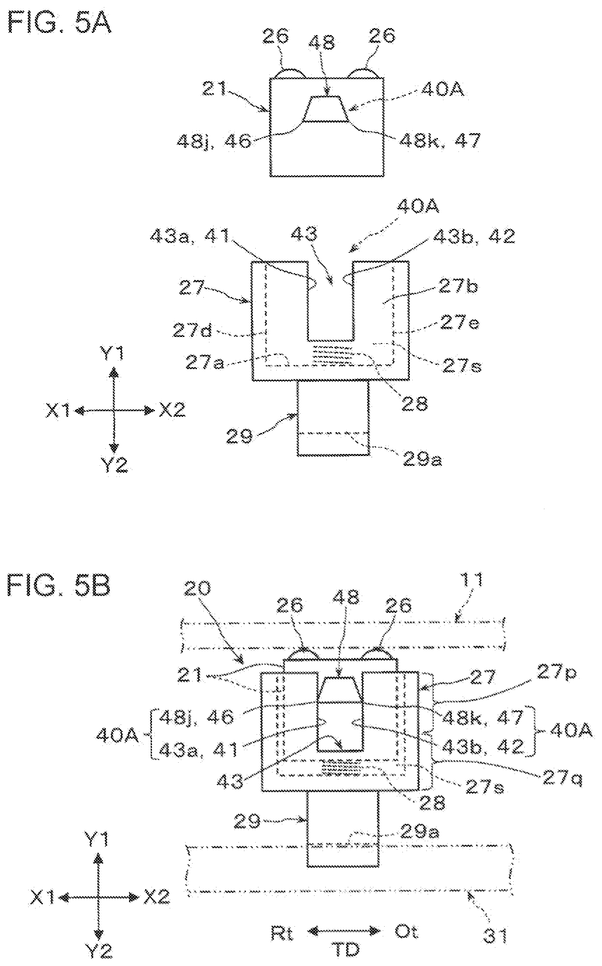

As illustrated in FIG. 3B, FIGS. 4A and 4B, FIGS. 5A and 5B, a positioning structural member 40A is provided at each of both ends of the reading unit 20 and the retainer 27 in a direction crossing the movement direction Ot at the time of reading by the reading unit 20. The movement direction Ot corresponds to the left and right directions X1, X2 in Exemplary Embodiment 1. In addition, the direction crossing the movement direction Ot is a substantially horizontal direction, and corresponds to the front and rear directions Z1, Z2 in Exemplary Embodiment 1.

The positioning structural member 40A has a positioning structure that maintains the reading unit 20 in a state of being displaceable relative to the retainer 27 in a direction to be closer to and in a direction to be away from the first transparent flat plate 11 and in a state of being non-displaceable upstream and downstream in the movement direction Ot at the time of reading by the reading unit 20.

The above-stated “being displaceable” refers to allowing displacement. In Exemplary Embodiment 1, the direction to be closer to the first transparent flat plate 11 corresponds to the upward direction Y1, and the direction to be away from the first transparent flat plate 11 corresponds to the downward direction Y2.

The positioning structural member 40A in Exemplary Embodiment 1 is comprised of: a pair of fixed sections 41, 42 provided parallel to the direction to be closer to and the direction to be away from the first transparent flat plate 11; and two contact sections 46, 47 that separately come into contact with the pair of fixed sections 41, 42 from upstream and downstream in the movement direction Ot at the time of reading. Thus, the positioning structural member 40A has a simple structure comprised of the pair of fixed sections 41, 42 and the two contact sections 46, 47.

In Exemplary Embodiment 1, upstream in the movement direction Ot corresponds to the left direction X1, and downstream in the movement direction Ot corresponds to the right direction X2.

In Exemplary Embodiment 1, the retainer 27 is provided with the pair of fixed sections 41, 42, and (the reading body 21 of) the reading unit 20 is provided with the two contact sections 46, 47.

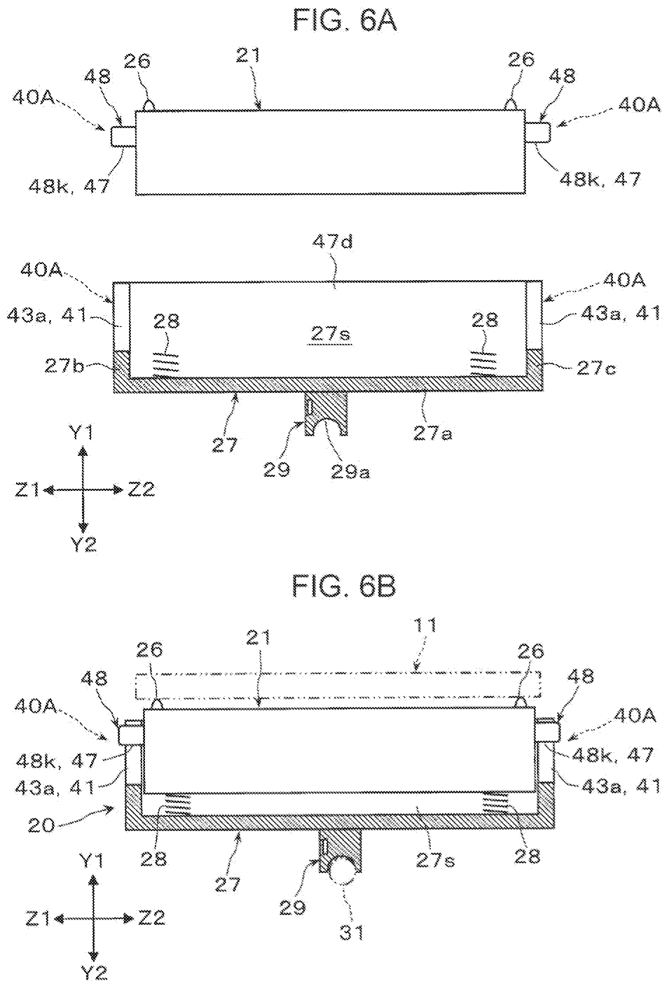

More specifically, as illustrated in FIG. 4A, FIG. 5A, FIG. 6A, in the positioning structural member 40A, the pair of fixed sections 41, 42 are formed as facing portions of a recessed section 43 which is linearly recessed in the direction in which the reading unit 20 is displaceable.

In the positioning structural member 40A, the two contact sections 46, 47 are formed as projecting portions of one body 48 which is inserted in the recessed section 43, the portions separately facing upstream and downstream in the movement direction Ot.

Here, the direction in which the reading unit 20 is displaceable is along the direction to be closer to and the direction to be away from the first transparent flat plate 11, and correspond to the upward and downward directions Y1, Y2 in Exemplary Embodiment 1.

The recessed section 43 in Exemplary Embodiment 1 is formed as a rectangular notch obtained by linearly cutting an upper portion of the short side sidewalls 27b, 27c of the retainer 27 so that the upper portion is recessed in the downward direction Y2. The facing portions of the recessed section 43 are opposed vertical sides 43a, 43b of the recessed section 43 in the movement direction Ot, and form a pair of fixed sections 41, 42.

Furthermore, as illustrated in FIG. 5A and others, the body 48 in Exemplary Embodiment 1 is a projecting structural body that projects outward from both ends of the reading body 21 in the longitudinal direction by a needed dimension, and has a cross-sectional shape of a trapezoid. The cross-sectional shape of a trapezoid is such that sides from both ends of the upper base spread downward to the lower base parallel to the upper base.

The two contact sections 46, 47 in Exemplary Embodiment 1 are formed as lower corners 48j, 48k that are both ends of the lower base of the body 48 in the movement direction Ot. Thus, the two contact sections 46, 47 are portions of the body 48, which separately face upstream and downstream in the movement direction Ot. The two contact sections 46, 47 are disposed at the same position (height) in the upward and downward directions Y1, Y2 of the retainer 27.

As illustrated in FIG. 5B, when the reading body 21 of the reading unit 20 is retained by the retainer 27, the two contact sections 46, 47 comprised of the lower corners 48j, 48k have a tip end shape such that the contact sections 46, 47 gradually narrow as closer to the pair of fixed sections 41, 42. Specifically, the tip end shape of the contact sections 46, 47 is a tapered shape.

The two contact sections 46, 47 are formed as portions (the lower corners 48j, 48k) of one body 48, thus have a simple structure and ensured strength. Since the tip end shape of the two contact sections 46, 47 is a tapered shape, as compared to when the tip end shape is, for example, a planar shape, it is possible to ensure smooth displacement of the reading body 21 of the reading unit 20 relative to the retainer 27 along the direction to be closer to and the direction to be away from the first transparent flat plate 11.

Furthermore, as illustrated in FIG. 5B, when the reading body 21 of the reading unit 20 is retained by the retainer 27, the two contact sections 46, 47 are positioned at an upper area 27p of the longitudinal ends of the retainer 27, the upper area 27p being closer to the first transparent flat plate 11.

The upper area 27p is the upper half area of the height dimension along the upward and downward directions Y1, Y2 of the ends of the retainer 27. A symbol 27q in FIG. 5B indicates the lower (lower half) of the ends of the retainer 27.

The specific positioning structural member 40A may be regarded as an example such that the pair of fixed sections 41, 42 are provided facing each other with an interval of a needed dimension in the movement direction Ot of the reading unit 20, and the two contact sections 46, 47 are formed as the portions that are inserted into the space between the pair of fixed sections 41, 42 to separately come into contact with the pair of fixed sections 41, 42.

As illustrated in FIG. 4B, FIG. 5B, FIG. 6B, the reading unit 20 having the above configuration is retained when the reading body 21 is stored in the storage space 27s of the retainer 27 with a needed gap.

In this process, in the reading body 21, the bodies 48 at both ends of the positioning structural member 40A are respectively inserted from above into the recessed sections 43 of the positioning structural member 40A in the retainer 27.

At this point, in the positioning structural member 40A, the two contact sections 46, 47 in the body 48 separately come into contact with the pair of fixed sections 41, 42 in the recessed sections 43. Specifically, as illustrated in FIG. 5B, one contact section 46 comes into contact with one fixed section 41 from downstream in the movement direction Ot, and the other contact section 47 comes into contact with the other fixed section 42 from upstream in the movement direction Ot.

When the bottom surface of the reading body 21 is further brought into contact with the urging member 28 installed at the base plate 27a of the retainer 27, storing of the reading body 21 into the retainer 27 is completed.

Consequently, the reading body 21 in the reading unit 20 is positioned by the positioning structural member 40A so that the reading body 21 is maintained in a state of being displaceable relative to the retainer 27 in a direction to be closer to and in a direction to be away from the first transparent flat plate 11 and is maintained in a state of being non-displaceable upstream and downstream in the movement direction Ot at the time of reading.

As illustrated in FIGS. 3A and 3B and others, when the retainer 27 is mounted on the guide member 31 in the movement unit 30 via the coupling mounting member 29, the reading unit 20 is maintained in a state of being displaceable relative to the retainer 27 by the positioning operation of the positioning structural member 40A in a direction to be closer to and in a direction to be away from the first transparent flat plate 11, while receiving the urging force F of the urging member 28 by the reading body 21.

Thus, the reading body 21 is maintained in a state of being in contact with the lower surface 11b of the first transparent flat plate 11 continuously with the contact sections 26 interposed therebetween, and as a result, the distance to the lower surface 11b of the first transparent flat plate 11 is maintained at a constant level, and the focal length of the condenser lens array 24 is also maintained stably.

In contrast, the positioning operation of the positioning structural member 40A causes the reading body 21 to be maintained in a state of being non-displaceable relative to the retainer 27 upstream and downstream in the movement direction Ot at the time of reading.

Consequently, even if the reading body 21 receives a varying external force from upstream and downstream in the movement direction Ot when being moved in the movement direction Ot at the time of reading, the reading body 21 is maintained in an immovable (non-swingable) posture relative to the retainer 27 in each direction upstream and downstream in the movement direction Ot.

Therefore, in the reading device 1, as compared to when the positioning structural member 40A is not provided, vibration of the reading unit 20 relative to the retainer 27 upstream and downstream in the movement direction Ot at the time of reading is prevented, the reading unit 20 being configured to move and read information on the object to be read 95 while being in contact with the lower surface 11b of the first transparent flat plate 11 on which the object to be read 95 is placed.

In addition, the reading device 1 is configured so that when the two contact sections 46, 47 are retained by the retainer 27 of the reading body 21, the two contact sections 46, 47 are positioned at the upper area 27p of the end of the retainer 27 (see FIG. 5B).

Therefore, in the reading device 1, as compared to a configuration in which the two contact sections 46, 47 are positioned at the lower area 27q away from the first transparent flat plate 11 of the retainer 27, vibration of the reading unit 20 relative to the retainer 27 upstream and downstream in the movement direction Ot at the time of reading is prevented more precisely.

### Exemplary Embodiment 2

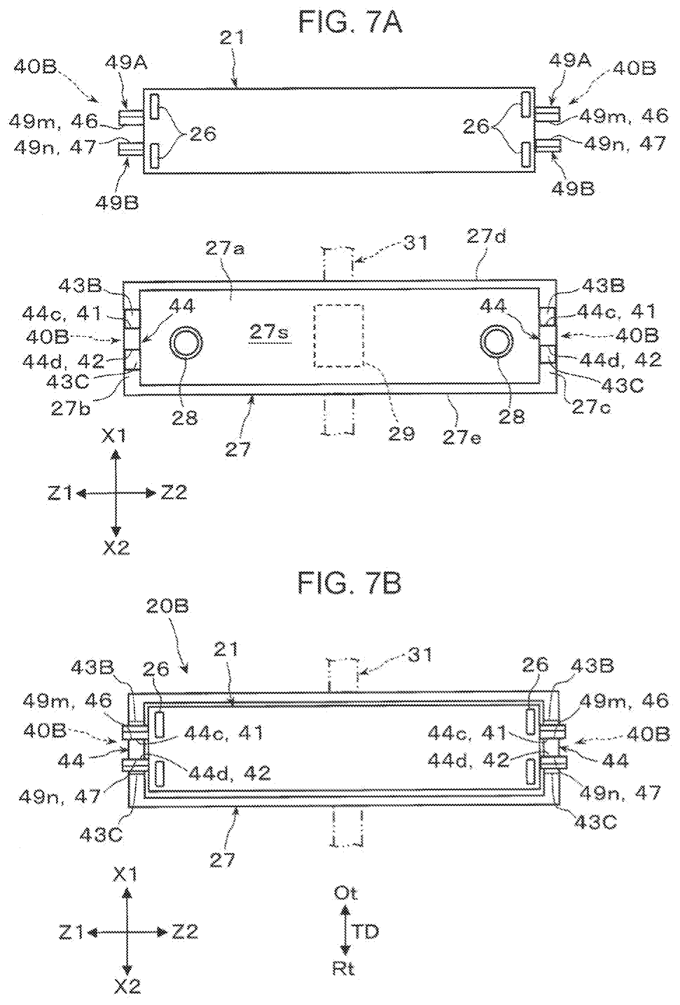

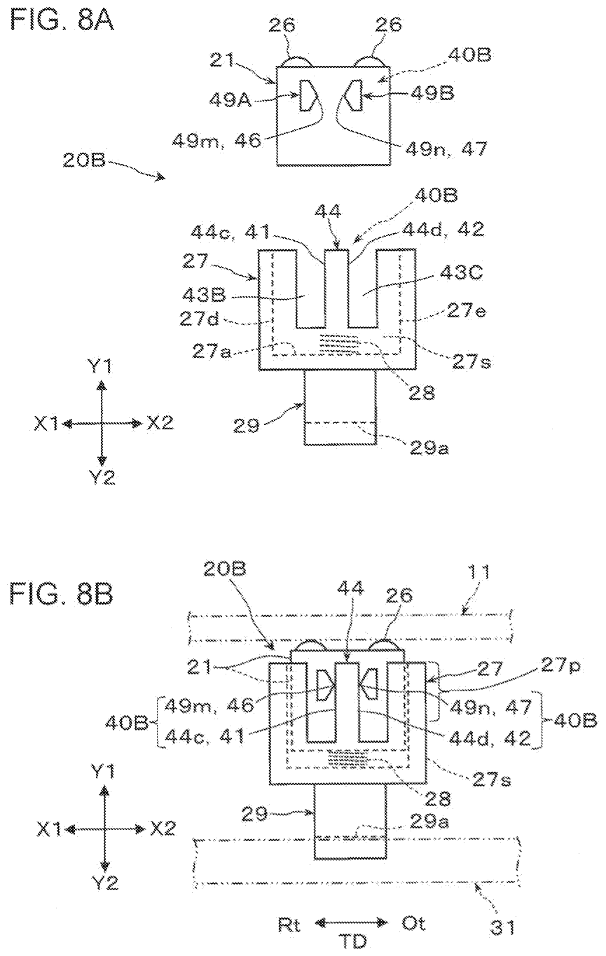

FIGS. 7A and 7B and FIGS. 8A and 8B are schematic views illustrating part (reading unit 20B) of a reading device according to Exemplary Embodiment 2.

The reading device according to Exemplary Embodiment 2 has the same configuration as that of the reading device 1 according to Exemplary Embodiment 1 except that a reading unit 20B having a partially different configuration is used as the reading unit 20.

The reading unit 20B differs from the reading unit 20 in Exemplary Embodiment 1 in that a positioning structural member 40B is used instead of the positioning structural member 40A. However, except for this, the reading unit 20B and the reading unit 20 have the same configuration.

That is, as in the reading unit 20 in Exemplary Embodiment 1, the positioning structural member 40B in Exemplary Embodiment 2 is configurated by the pair of fixed sections 41, 42 and the two contact sections 46, 47, and specifically, has the following configuration.

In the positioning structural member 40B, the pair of fixed sections 41, 42 are formed as sides 44c, 44d that are present on both sides of a columnar member 44 in the extension direction, the columnar member 44 extending linearly in the displaceable direction.

In the positioning structural member 40B, the two contact sections 46, 47 are formed as portions of two supports 49A, 49B that are closely arranged and interpose the columnar member 44 from upstream and downstream in the movement direction Ot, the portions facing the sides 44c, 44d present on both sides of the columnar member 44.

The columnar member 44 in Exemplary Embodiment 1 is formed as a columnar structure section comprised of a cuboid in upper portions of the short side sidewalls 27b, 27c of the retainer 27, the cuboid being present between two rectangular recessed sections 43B, 43C which are obtained by linearly cutting the upper portions with an interval so that the upper portions are recessed in the downward direction Y2. The sides 44c, 44d present on both sides of the columnar member 44 in the extension direction are vertical lateral sides of the columnar member 44, and form the pair of fixed sections 41, 42, the vertical lateral sides separately facing upstream and downstream in the movement direction Ot.

As illustrated in FIG. 7A and FIG. 8A, the two supports 49A, 49B in Exemplary Embodiment 2 are projecting structural bodies that project outward from two positions at both ends of the reading body 21 in the longitudinal direction by a needed dimension, and has a cross-sectional shape of a pentagon. The cross-sectional shape of a pentagon is such that the sections in tapered tip end shapes face each other in the movement direction Ot with a needed interval.

The two contact sections 46, 47 in Exemplary Embodiment 2 are formed as pointed portions 49m, 49n of the two supports 49A, 49B in tapered tip end shapes facing each other with an interval. Thus, the two contact sections 46, 47 are sections facing each other with an interval in the movement direction Ot in the two supports 49A, 49B.

As illustrated in FIG. 8B, when the reading body 21 of the reading unit 20 is retained by the retainer 27, the two contact sections 46, 47 comprised of the pointed portions 49m, 49n have a tip end shape such that the contact sections 46, 47 gradually narrow as closer to the pair of fixed sections 41, 42 in the reading body 21.

Since the pair of fixed sections 41, 42 are formed as the sides 44c, 44d that are present on both sides of the columnar member 44 in the extension direction, the interval (width) therebetween in the movement direction Ot can be reduced, as compared to the pair of fixed sections 41, 42 comprised of the vertical facing sides 43a, 43b of the recessed section 43 in Exemplary Embodiment 1.

The specific positioning structural member 40B may be regarded as an example such that one fixed section between the pair of fixed sections 41, 42 is provided facing upstream in the movement direction Ot, and the other fixed section is provided facing downstream in the movement direction Ot with back against the one fixed section, and the two contact sections 46, 47 are formed as portions that interpose the pair of fixed sections 41, 42 from upstream and downstream in the movement direction Ot, and separately come into contact with the fixed sections 41, 42.

As illustrated in FIG. 7B, FIG. 8B, the reading unit 20B having the above configuration is retained when the reading body 21 is stored in the storage space 27s of the retainer 27 with a needed gap.

In this process, in the reading body 21, the two supports 49A, 49B of the positioning structural member 40B at both ends are respectively inserted from above into the two recessed sections 43B, 43C of the positioning structural member 40B at longitudinal both ends of the retainer 27.

At this point, in the positioning structural member 40B, the two contact sections 46, 47 separately provided in the two supports 49A, 49B are moved to interpose and separately come into contact with the pair of fixed sections 41, 42 of the columnar member 44 between two recessed sections 43B, 43C from upstream and downstream in the movement direction Ot. Specifically, as illustrated in FIG. 8B, one contact section 46 comes into contact with one fixed section 41 from upstream in the movement direction Ot, and the other contact section 47 comes into contact with the other fixed section 42 from downstream in the movement direction Ot.

When the bottom surface of the reading body 21 is further brought into contact with the urging member 28, storing of the reading body 21 into the retainer 27 is completed.

Consequently, the reading body 21 in the reading unit 20B is positioned by the positioning structural member 40B so that the reading body 21 is maintained in a state of being displaceable relative to the retainer 27 in a direction to be closer to and in a direction to be away from the first transparent flat plate 11 and is maintained in a state of being non-displaceable upstream and downstream in the movement direction Ot at the time of reading.

When the retainer 27 is mounted on the guide member 31 in the movement unit 30 via the coupling mounting member 29, the reading unit 20B is also positioned relative to the retainer 27 of the reading body 21 in substantially the same manner as in the reading unit 20 (see FIG. 3 and others) in Exemplary Embodiment 1.

Specifically, the reading unit 20B is also maintained in a state of being displaceable relative to the retainer 27 by the positioning operation of the positioning structural member 40A in a direction to be closer to and in a direction to be away from the first transparent flat plate 11, while receiving the urging force F of the urging member 28 by the reading body 21. In contrast, the positioning operation of the positioning structural member 40B causes the reading body 21 to be maintained in a state of being non-displaceable relative to the retainer 27 upstream and downstream in the movement direction Ot at the time of reading.

Therefore, also in the reading device according to Exemplary Embodiment 2, as compared to when the positioning structural member 40B is not provided, vibration of the reading unit 20 relative to the retainer 27 upstream and downstream in the movement direction Ot is prevented, the reading unit 20 being configured to move and read information on the object to be read 95 while being in contact with the lower surface 11b of the first transparent flat plate 11 on which the object to be read 95 is placed.

In addition, also in the reading device, the above-described operational effects related to the reading unit 20 in Exemplary Embodiment 1 are obtained in substantially the same manner.

### Exemplary Embodiment 3

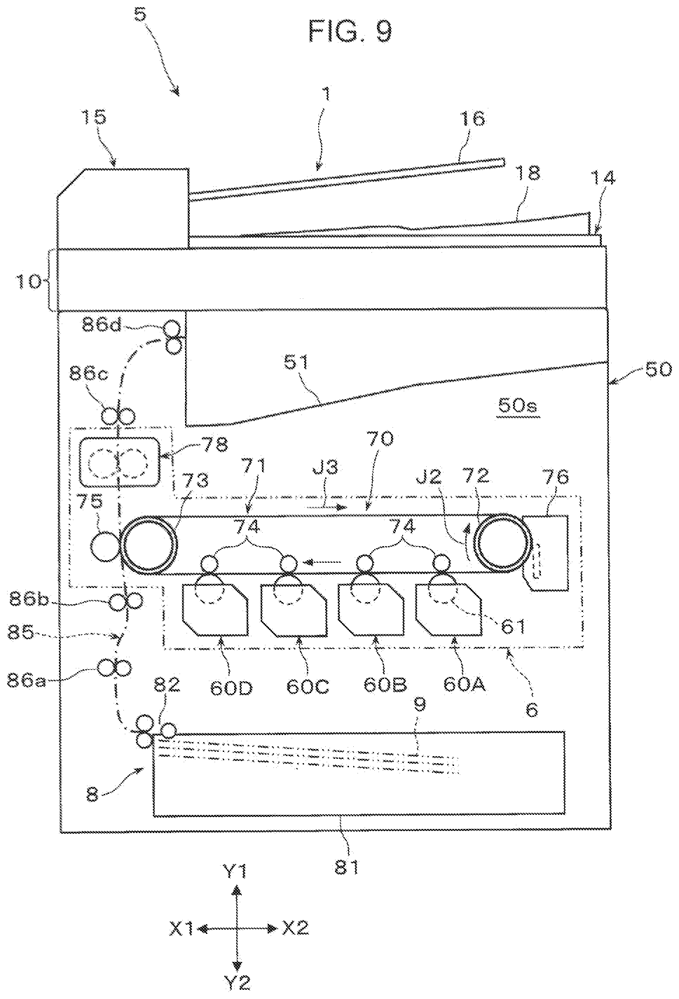

FIG. 9 is a schematic view of an image forming apparatus 5 including the reading device 1 according to Exemplary Embodiment 3, and is an enlarged schematic view of an imaging unit 60 in the image forming apparatus 5.

As illustrated in FIG. 9, the image forming apparatus 5 includes: a housing 50; an image forming unit 6 and a medium supply unit 8 disposed inside the housing 50; and a reading device 1 disposed above the upper surface of the housing 50. In addition, the image forming apparatus 5 has functions as a copier and a printer at least.

The housing 50 is a structural body having an internal framework section and an external exterior section.

The housing 50 in Exemplary Embodiment 1 is formed as a structural body in a cuboid shape, which is slightly longer in the upward and downward directions Y1, Y2 than in the left and right directions X1, X2.

In addition, the housing 50 includes: an internal storage space 50s in which the image forming unit 6 and the medium supply unit 8 are stored and disposed; and a discharge storage 51 that discharges and stores a recording medium 9 on which an image is formed. The discharge storage 51 is provided, for example, in the upper surface of the housing 50 as a diagonally recessed inclined surface.

The image forming unit 6 is a component that can also form, as an image, information on the object to be read 95 read by the reading device 1 on a recording medium 9.

The image forming unit 6 in Exemplary Embodiment 3 is a unit using an electrophotographic system, and includes: the imaging unit 60 that forms a toner image composed of toner; an intermediate transfer unit 70 that relays the toner image formed by the imaging unit 60 and transfers the toner image to a recording medium 9; and a fixing device 78 that fixes the toner image transferred to the recording medium 9 onto the recording medium 9. The image forming unit 6 can be regarded as a unit which also includes the medium supply unit 8 that stores and supplies recording media 9.

The imaging unit 60 is comprised of four imaging units 60A, 60B, 60C, 60D that exclusively form respective color toner images composed of toner of four colors (yellow, magenta, cyan, black), for example. The four imaging units 60A, 60B, 60C, 60D are linearly disposed in the storage space 50s of the housing 50.

In addition, the four imaging units 60A, 60B, 60C, 60D have substantially the same configuration except that the colors of toner to be used are the four different colors mentioned above.

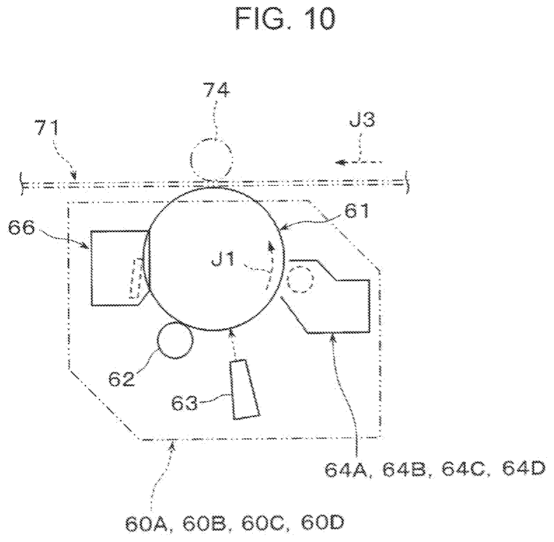

Specifically, as illustrated in FIG. 10, the imaging units 60A, 60B, 60C, 60D each have a drum-shaped photoreceptor 61 which is an example of an image carrier. Also, in the imaging units 60A, 60B, 60C, 60D, devices are disposed around the photoreceptor 61, the devices including a charging device 62, a latent image forming device (image exposure device) 63, developing devices 64A, 64B, 64C, 64D, and a cleaning device 66 that cleans the image carrier surface of the photoreceptor 61.

The photoreceptor 61 is an image carrier having a photosensitive layer and an image carrier surface to carry an electrostatic latent image and a toner image, and rotates in the direction (rotation direction J1) indicated by an arrow.

The latent image forming device 63 is a device that performs exposure based on image information on the image carrier surface of the photoreceptor 61 after being charged to form an electrostatic latent image. The latent image forming device 63 operates upon receiving an image signal generated by an image processing unit (not illustrated) performing a needed process on information on an image input from the reading device 1 or the outside.

The developing device 64A, 64B, 64C, or 64D exclusively uses toner of one color of the above-mentioned four colors. As the toner, for example, toner of a two-component developer containing toner and carrier is used.

The intermediate transfer unit 70 is configured by disposing: an endless belt-shaped intermediate transfer body 71; support rollers 72, 73 that rotatably support the intermediate transfer body 71; a first transfer roller 74; a second transfer roller 75; and a cleaning device 76 that cleans the image carrier surface of the intermediate transfer body 71.

The intermediate transfer body 71 is an endless belt having an image carrier surface that carries a toner image of each color formed by the imaging units 60A, 60B, 60C, 60D. The intermediate transfer body 71 rotates so as to circulate and move in rotation direction J3 indicated with an arrow by the support roller 72 which rotates in the direction (rotation direction J2) indicated with an arrow.

The first transfer roller 74 is a transfer device that uses a press-rotation method to press the intermediate transfer body 71 against each photoreceptor 61 for rotation at the position (first transfer position) where the intermediate transfer body 71 faces each photoreceptor 61 of the imaging units 60A, 60B, 60C, 60D. The first transfer roller 74 first transfers a toner image formed on each photoreceptor 61 onto the image carrier surface of the intermediate transfer body 71.

The second transfer roller 75 is a transfer device that uses a press-rotation method to press the intermediate transfer body 71 against the support roller 73 for rotation at the position (second transfer position) where the intermediate transfer body 71 faces the support roller 73. The second transfer roller 75 collectively transfers toner images first transferred to the intermediate transfer body 71 onto a recording medium 9.

The fixing device 78 is a device that fixes the toner images second transferred at the second transfer position of the intermediate transfer unit 70 onto a recording medium 9.

The fixing device 78 is formed by disposing devices, such as a rotating body for heating, a rotating body for pressure, in the internal space of a housing provided with an inlet port and a discharge port for the recording media 9. In the fixing device 78, a section in which the rotating body for heating and the rotating body for pressure are in pressure-contact with each other serves as a fixing nip part to perform a process of fixing.

The medium supply unit 8 is a device that stores and sends recording media 9 in a needed size to be supplied to the second transfer position of the intermediate transfer unit 70. The medium supply unit 8 is formed by disposing a medium storage 81 that stores recording media 9, and a delivery device 82 that delivers the recording media 9 in the medium storage 81 sheet by sheet.

The recording medium 9 may be a sheet-like medium which can be stored and transported, and on which a toner image can be transferred and fixed inside the housing 50. As the recording medium 9, regular paper, coated paper, cardboard, envelope may be mentioned; however, its material, and form are not particularly limited.

The dash-dot-dash line indicated by a symbol 85 in FIG. 9 shows the major transport path along which the recording medium 9 is transported inside the housing 50. The transport path 85 is formed by disposing multiple transport rollers 86a, 86b, 86c, 86d that pinch and transport the recording medium 9, and multiple guide members (not illustrated) that ensure the transport space for the recording medium 9 and guide the transport of the recording medium 9.

In the image forming apparatus 5, as the reading device 1, the reading device 1 according to Exemplary Embodiments 1, 2 is used.

As illustrated in FIG. 9, the reading device 1 is mounted so that the housing 10 is installed to be opposed to the upper surface of the housing 50 of the image forming apparatus 5. In addition, the reading device 1 is disposed to cover the upper space of the discharge storage 51 of the housing 50. Furthermore, the reading device 1 is coupled to a power supply, an image processor, and a controller which are disposed in the housing 50 and not illustrated.

The image forming apparatus 5 can selectively perform an image forming operation as a copier to form information on the object to be read 95 read by the reading device 1 as an image copied to the recording medium 9, and an image forming operation as a printer to form information on an image input from a connected device such as an external terminal as an image recorded on the recording medium 9.

### Image Forming Operation

The image forming operation by the image forming apparatus 5 is performed in the following manner, for example.

Hereinafter the above-mentioned image forming operation as the copier will be representatively described. The image formed in the following description is a multicolor image, so-called a full color image which is formed by combining toner of four colors: yellow, magenta, cyan and black.

First, in the image forming apparatus 5, a reading operation in the fixed document reading mode or a reading operation in the moving document reading mode is performed on needed information on the object to be read 95 in the reading device 1.

Subsequently, when a control unit (not illustrated) receives a command for an image forming operation in the image forming apparatus 5, in the imaging units 60A, 60B, 60C, 60D and the intermediate transfer unit 70 in the image forming unit 6, a charging operation, an exposure operation, a developing operation, a transfer operation, and a cleaning operation are each performed. Meanwhile, in the image forming apparatus 5, an operation of supplying a medium to the second transfer position of the recording medium 9 is executed in the medium supply unit 8 which is part of the image forming unit 6. In this process, in the exposure operation, exposure of image components is performed based on the information on the object to be read 95 read by the reading device 1.

Thus, in the image forming apparatus 5, a toner image of a predetermined color is formed on each drum-shaped photoreceptor 61 of the imaging units 60A, 60B, 60C, 60D. Also, in the image forming apparatus 5, after a toner image of each color is first transferred to the drum-shaped intermediate transfer body 71 in the intermediate transfer unit 70, the toner image is superimposedly second transferred to the recording medium 9 supplied to the second transfer position through the transport path 85.

Subsequently, in the fixing device 78 of the image forming apparatus 5, a fixing operation is performed in which the recording medium 9 with a toner image second transferred is guided and passed through the fixing nip part where the rotating body for heating and the rotating body for pressure come into contact with each other.

Consequently, in the image forming apparatus 5, an unfixed toner image is heated under pressure, and fixed onto the recording medium 9. The recording medium 9 after fixing is discharged to and stored in the discharge storage 51 through the transport path 85.

A basic operation of forming a multicolor image on one side of a recording medium 9 by the image forming apparatus 5 is completed by the above-described operation.

In the image forming apparatus 5, when image formation is performed corresponding to information on the object to be read 95 read by the reading device 1 in the fixed document reading mode, the following effects are obtained.

Specifically, in the image forming apparatus 5, as compared to when the reading device 1 is not provided with the positioning structural member 40A or 40B, vibration of the reading units 20, 20B relative to the retainer 27 upstream and downstream in the movement direction Ot at the time of reading is prevented. As a result, in the image forming apparatus 5, reduction in the quality of an image formed corresponding to information on the object to be read 95, due to the above-mentioned vibration in the reading device 1 is decreased, the information being read by the reading device 1 in the fixed document reading mode.

### Modifications

Although the exemplary embodiments of the present disclosure have been described above, the present disclosure is not limited to the configuration exemplified in Exemplary Embodiment 1 or 2, and various modifications and implementations are possible in a range without departing from the gist of the present disclosure. Thus, the present disclosure also includes, for example, the modifications shown below.

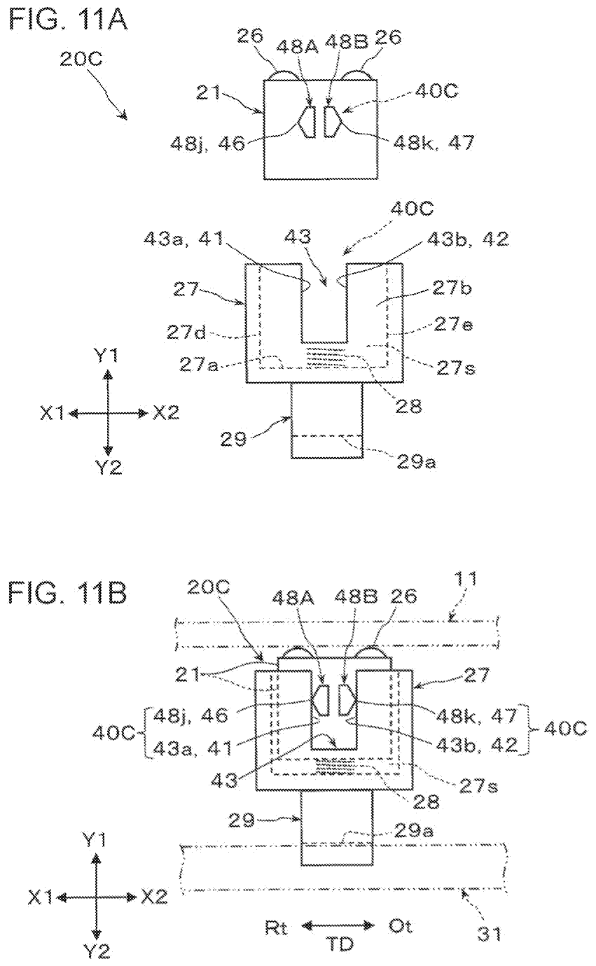

As illustrated in FIGS. 11A and 11B, the reading unit 20 in Exemplary Embodiment 1 may be changed to a reading unit 20C of Modification 1 that uses a positioning structural member 40C in which divided two bodies 48A, 48B are used instead of one body 48 (see FIGS. 5A and 5B) provided with the contact sections 46, 47.

The two bodies 48A, 48B in the positioning structural member 40C of the reading unit 20C in Modification 1 are produced as the remaining portion after deleting (removing) the central portion of one body 48 in the movement direction Ot, for example. In addition, the two bodies 48A, 48B are produced by changing (making change so that the pointed portions 49m, 49n separately face upstream and downstream in the movement direction Ot) the posture of the two supports 49A, 49B (see FIGS. 5A and 5B) in Exemplary Embodiment 2.

In this case, of the two contact sections 46, 47, one contact section 46 is formed as a pointed portion 48j in a tapered tip end shape, facing upstream in the movement direction Ot in one body 48A. Also, the other contact section 47 is formed as a pointed portion 48k in a tapered tip end shape, facing downstream in the movement direction Ot in the other body 48B. At this point, the two contact sections 46, 47 are sections that separately face upstream and downstream in the movement direction Ot.

The divided two bodies 48A, 48B in the positioning structural member 40C are effective, for example, when the bodies are difficult to be produced as one body 48 due to some circumstances (such as presence of other components which cannot be changed in position).

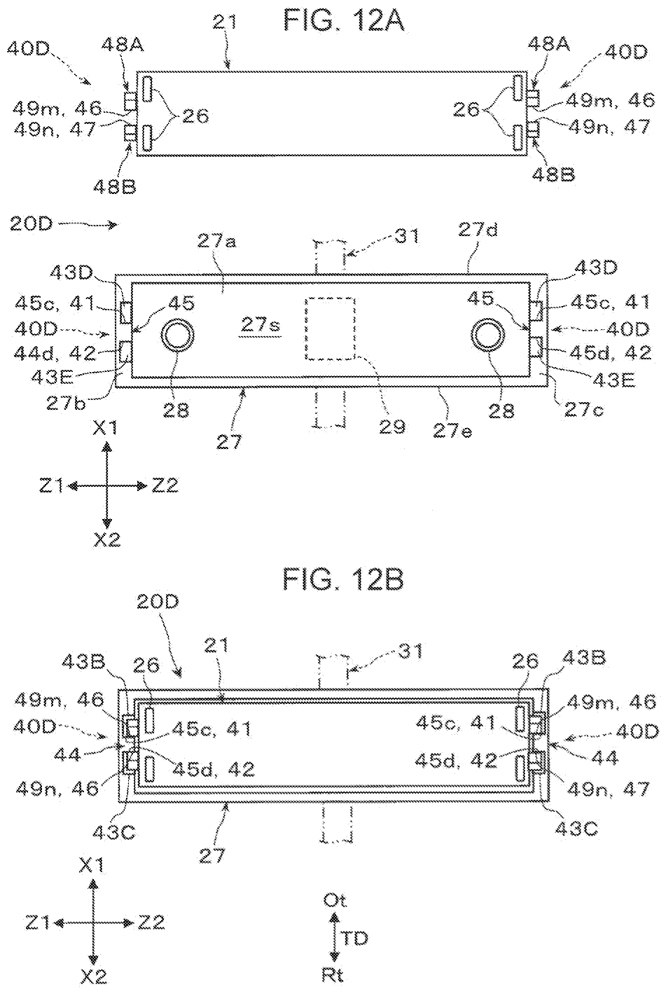

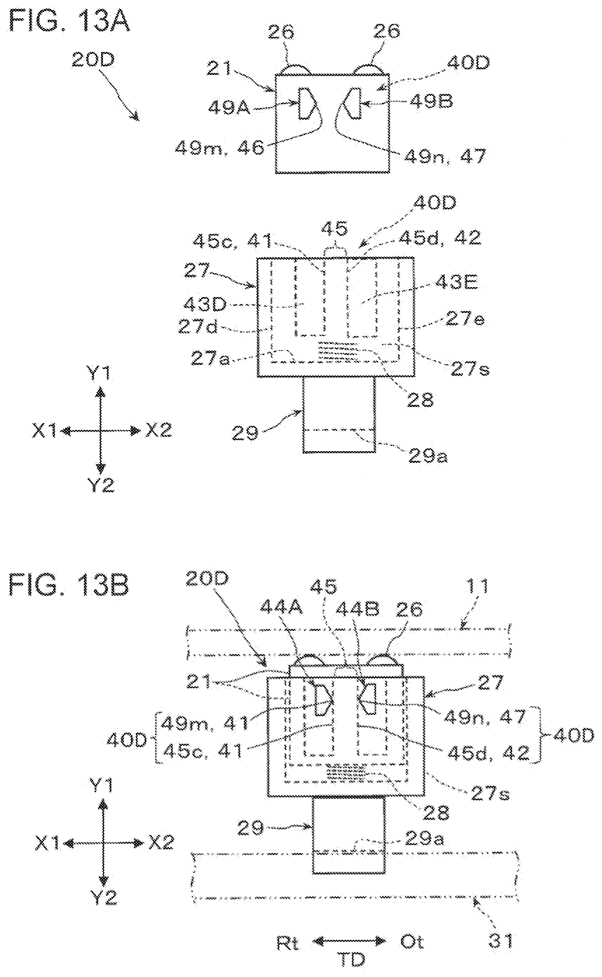

As illustrated in FIGS. 12A and 12B an FIGS. 13A and 13B, the reading unit 20B in Exemplary Embodiment 2 may be changed to a reading unit 20D of Modification 2 provided with a positioning structural member 40D in which a bulge member is used instead of the columnar member 44 (see FIGS. 8A and 8B) provided with the pair of fixed sections 41, 42.

The bulge member 45 of the positioning structural member 40D in the reading unit 20D of Modification 2 is formed as a structure section in upper portions of the short side sidewalls 27b, 27c of the retainer 27, the structure section being present between two rectangular groove sections 43D, 43E which are obtained by cutting off the upper portions so that the groove sections linearly extend with an interval and are recessed only on the inner surface side in the downward direction Y2. In other words, the bulge member 45 is formed as a structure section that bulges in a rectangular shape from the groove sections 43D, 43E to the storage space 27s of the retainer 27.

In this case, the sides 44c, 44d present on both sides of the bulge member 45 in the extension direction are vertical lateral sides of the bulge member 45, and form the pair of fixed sections 41, 42, the vertical lateral sides separately facing upstream and downstream in the movement direction Ot.

The two contact sections 46, 47 are formed as part (pointed portions) 49m, 49n of the two supports 49A, 49B, the part having an amount of projection less than that of the two supports 49A, 49B in the positioning structural member 40B of the reading unit 20B in Exemplary Embodiment 2.

In the positioning structural member 40D, when the reading body 21 in the reading unit 20 is stored and retained in the retainer 27, two bodies 48A, 48B are inserted into two grooves 43D, 43E. In this process, the reading unit 20D is positioned such that the two contact sections 46, 47 in the two bodies 48A, 48B in the positioning structural member 40D separately come into contact with the pair of fixed sections 41, 42 on both side of the bulge member 45 in the positioning structural member 40D.

The bulge member 45 in the positioning structural member 40D is effective, for example, when the short side sidewalls 27b, 27c of the retainer 27 cannot be provided with the recessed section 43 having both sides open (or the columnar member 44, see FIGS. 7A and 7B, FIGS. 8A and 8B) due to some circumstances.

Although the positioning structural members 40A, 40B, 40C, 40D are provided at longitudinal both ends of the reading body 21 and the retainer 27 in the reading units 20, 20B in Exemplary Embodiments 1, 2, and the reading units 20C, 20D in Modifications 1, 2, the positioning structural members 40A, 40B, 40C, 40D may be provided at one end only.

The tip end shape of the two contact sections 46, 47 may be a planar shape along the pair of fixed sections 41, 42, but may be a tapered shape that gradually narrows as closer to the pair of fixed sections 41, 42. As the shape that gradually narrows as closer thereto, for example, a semicircle shape, an elliptical shape may be used other than a tapered shape.

In the reading device 1, the second transparent flat plate 12 and the automatic document transport device 15 may not be disposed.

The image forming apparatus 5 exemplified in Exemplary Embodiment 3 is not limited to an image forming apparatus that forms a multicolor image, and may be an image forming apparatus that forms a monochrome image of a single color (for example, black).

In the image forming apparatus 5, the image forming unit 6 is not limited to an electrophotographic image forming unit 6 that forms, as an image composed of toner, information on the object to be read 95 read by the reading device 1 onto a recording medium 9, and an image forming unit 6 adopting an image forming system other than the electrophotographic system may be used. The image forming system other than the electrophotographic system includes, for example, a liquid droplet ejection method, a heat-sensitive method, and a printing method.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))
   A reading device comprising:
   a transparent flat plate, on an upper surface of which an object to be read is placed; a reading unit that reads information on the object to be read while moving in contact with a lower surface of the transparent flat plate;
   a retainer that retains the reading unit by urging the reading unit to be pressed against the lower surface of the transparent flat plate;
   a guide member that supports and guides the retainer along a movement direction at a time of reading by the reading unit; and
   a positioning structural member provided in at least one end of the reading unit and the retainer in a direction crossing the movement direction to position the reading unit so that the reading unit is maintained in a state of being displaceable relative to the retainer in a direction to be closer to and in a direction to be away from the transparent flat plate and in a state of being non-displaceable upstream and downstream in the movement direction.
(((2)))
   The reading device according to (((1))),
   wherein the positioning structural member includes: a pair of fixed sections provided parallel to the direction to be closer to and the direction to be away from the transparent flat plate; and two contact sections that separately come into contact with the pair of fixed sections from upstream and downstream in the movement direction.
(((3)))
   The reading device according to (((2))),
   wherein the pair of fixed sections are provided facing each other with an interval in the movement direction, and the two contact sections are formed as portions that are inserted into a space between the pair of fixed sections to separately come into contact with the pair of fixed sections.
(((4)))
   The reading device according to (((2))),
   wherein one of the pair of fixed sections is provided facing upstream in the movement direction, and the other fixed section is provided facing downstream in the movement direction with back against the one fixed section, and the two contact sections are formed as portions that interpose the pair of fixed sections from upstream and downstream in the movement direction, and separately come into contact with the fixed sections.
(((5)))
   The reading device according to (((3))),
   wherein the pair of fixed sections are formed as facing portions of a recessed section which is linearly recessed in the direction in which the reading unit is displaceable, and
   the two contact sections are formed as projecting portions of one body which is inserted in the recessed section, the portions separately facing upstream and downstream in the movement direction.
(((6)))
   The reading device according to (((4))),
   wherein the pair of fixed sections are formed as sides that are present on both sides of a bulge member or a columnar member in an extension direction, the bulge member or the columnar member extending linearly in the direction in which the reading unit is displaceable, and
   the two contact sections are formed as portions of supports that are closely arranged and interpose the bulge member or the columnar member from upstream and downstream in the movement direction, the portions facing sides present on both sides of the bulge member or the columnar member.
(((7)))
   The reading device according to (((2))),
   wherein the two contact sections are formed as portions that have a tip end shape such that the contact sections gradually narrow as closer to the pair of fixed sections.
(((8)))
   The reading device according to any one of (((2))) to (((7))),
   wherein when the reading unit is retained by the retainer, the two contact sections are positioned in an upper area of part of the at least one end of the retainer, the part being closer to the transparent flat plate.
(((9)))
   The reading device according to any one of (((1))) to (((8))),
   wherein the retainer is provided with the pair of fixed sections, and the reading unit is provided with the two contact sections.
(((10)))
   An image forming apparatus comprising:
   the reading device according to any one of (((1))) to (((9))); and
   an image forming unit that forms information read by the reading device as an image on a recording medium.

What is claimed is:

1. A reading device comprising:
a transparent flat plate, on an upper surface of which an object to be read is placed;
a reading unit that reads information on the object to be read while moving in contact with a lower surface of the transparent flat plate;
a retainer that retains the reading unit by urging the reading unit to be pressed against the lower surface of the transparent flat plate;
a guide member that supports and guides the retainer along a movement direction at a time of reading by the reading unit; and
a positioning structural member provided in at least one end of the reading unit and the retainer in a direction crossing the movement direction to position the reading unit so that the reading unit is maintained in a state of being displaceable relative to the retainer in a direction to be closer to and in a direction to be away from the transparent flat plate and in a state of being non-displaceable upstream and downstream in the movement direction.

2. The reading device according to claim 1,
wherein the positioning structural member includes: a pair of fixed sections provided parallel to the direction to be closer to and the direction to be away from the transparent flat plate; and two contact sections that separately come into contact with the pair of fixed sections from upstream and downstream in the movement direction.

3. The reading device according to claim 2,
wherein the pair of fixed sections are provided facing each other with an interval in the movement direction, and the two contact sections are formed as portions that are inserted into a space between the pair of fixed sections to separately come into contact with the pair of fixed sections.

4. The reading device according to claim 2,
wherein one of the pair of fixed sections is provided facing upstream in the movement direction, and the other fixed section is provided facing downstream in the movement direction with back against the one fixed section, and
the two contact sections are formed as portions that interpose the pair of fixed sections from upstream and downstream in the movement direction, and separately come into contact with the fixed sections.

5. The reading device according to claim 3,
wherein the pair of fixed sections are formed as facing portions of a recessed section which is linearly recessed in the direction in which the reading unit is displaceable, and
the two contact sections are formed as projecting portions of one body which is inserted in the recessed section, the portions separately facing upstream and downstream in the movement direction.

6. The reading device according to claim 4,
wherein the pair of fixed sections are formed as sides that are present on both sides of a bulge member or a columnar member in an extension direction, the bulge member or the columnar member extending linearly in the direction in which the reading unit is displaceable, and
the two contact sections are formed as portions of supports that are closely arranged and interpose the bulge member or the columnar member from upstream and downstream in the movement direction, the portions facing sides present on both sides of the bulge member or the columnar member.

7. The reading device according to claim 2,
wherein the two contact sections are formed as portions that have a tip end shape such that the contact sections gradually narrow as closer to the pair of fixed sections.

8. The reading device according to claim 2,
wherein when the reading unit is retained by the retainer, the two contact sections are positioned in an upper area of part of the at least one end of the retainer, the part being closer to the transparent flat plate.

9. The reading device according to claim 1,
wherein the retainer is provided with the pair of fixed sections, and the reading unit is provided with the two contact sections.

10. An image forming apparatus comprising:
the reading device according to claim 1; and
an image forming unit that forms information read by the reading device as an image on a recording medium.

11. An image forming apparatus comprising:
the reading device according to claim 2; and
an image forming unit that forms information read by the reading device as an image on a recording medium.

12. An image forming apparatus comprising:
the reading device according to claim 3; and
an image forming unit that forms information read by the reading device as an image on a recording medium.

13. An image forming apparatus comprising:
the reading device according to claim 4; and
an image forming unit that forms information read by the reading device as an image on a recording medium.

14. An image forming apparatus comprising:
the reading device according to claim 5; and
an image forming unit that forms information read by the reading device as an image on a recording medium.

15. An image forming apparatus comprising:
the reading device according to claim 6; and
an image forming unit that forms information read by the reading device as an image on a recording medium.

16. An image forming apparatus comprising:
the reading device according to claim 7; and
an image forming unit that forms information read by the reading device as an image on a recording medium.

17. An image forming apparatus comprising:
the reading device according to claim 8; and
an image forming unit that forms information read by the reading device as an image on a recording medium.

18. An image forming apparatus comprising:
the reading device according to claim 9; and
an image forming unit that forms information read by the reading device as an image on a recording medium.

19. A reading device comprising:
means for placing an object to be read on an upper surface;
means for reading information on the object to be read while moving in contact with a lower surface of the means for placing an object to be read;
means for retaining the means for reading information by urging the means for reading information to be pressed against the lower surface of the means for placing an object to be read;
means for supporting and guiding the means for retaining along a movement direction at a time of reading by the means for reading information; and
means provided in at least one end of the means for reading information and the means for retaining in a direction crossing the movement direction for positioning the means for reading information so that the means for reading information is maintained in a state of being displaceable relative to the means for retaining in a direction to be closer to and in a direction to be away from the means for placing an object to be read and in a state of being non-displaceable upstream and downstream in the movement direction.
